(19) United States
(12) Patent Application Publication
(10) Pub. No.: US 2006/0159236 A1
(43) Pub. Date: Jul. 20, 2006

(54) Electronic directory telephone

(76) Inventor: Zouhir Al-Samadi, Damascus (SY)

Correspondence Address: CHAUZA & HANDLEY, L.L.P., PO BOX 140036, IRVING, TX, 75014, US

(21) Appl. No.: 11/038,979

(22) Filed: Jan. 19, 2005

(51) Int. Cl. H04M 1/64

(52) U.S. Cl. 379/67.1

(57) ABSTRACT

An electronic directory and advertising telephone (“EDP”) includes a telephone handset (6), a display monitor (32), a keyboard (20), and removable memory media (44). The removable memory media (44) preferably includes telephone listings and advertisements, is registered for use with a particular EDP, and is replaced every year. The advertisements include graphical displays, or pictures, which are scheduled to appear on the display monitor (32) during predetermined calendar dates. Advertisements are linked to telephone listings, and appear when linked a telephone listing is connected to the EDP. A series of activation codes are stored on the EDP, and each year a new EDP activation code must be entered which matches a selected one of the series of stored activation codes. The EDP also includes functions for games (478), a calendar (498), an appointments reminder (312), and displaying prayer times (490) and directions toward Qa'aba-Qebla, in Mecca (486).

### TECHNICAL FIELD OF THE INVENTION

The present invention relates in general to telecommunication devices, and in particular to a telephone having a directory and a display for advertisements.

### BACKGROUND OF THE INVENTION

Prior art telephones have been provided for use in making and receiving telephone calls. Some prior art telephones have included electronic memory for storing a phone book in which a limited lists of names and numbers corresponding to the names are stored, and for storing a listing of recent calls made to the telephone and from the telephone. Telephones have also been provided which display the identity and listed telephone number of a caller.

### SUMMARY OF THE INVENTION

A novel electronic home and business directory and advertisement display telephone (“EDP”) is disclosed having a telephone handset, a display monitor, a keyboard and a removable memory media, such as an SD card. EDPs can be manufactured in various forms, such as a display telephone for home and office use, a display cellular telephone, and as a display public telephone, with the same software and functionality available for each. Residential and business telephone listings are stored on the removable memory media, as well as advertisements. The advertisements include graphical displays, such as pictures and text. Some of the advertisements are scheduled to appear on EDP display monitors of in sequence during predetermined dates of the year and for certain predetermined periods. Time periods for scheduled display are preferably of a few seconds in duration for each of the advertisements. The scheduled sequence of advertisements appears continuously when an EDP is not being used. Some of the advertisements scheduled for display are not linked to the telephone numbers of business listings stored on the removable media, but the advertisements will contain telephone number information for display within the advertisements.

Some of the advertisements scheduled for display are linked to the telephone numbers of business telephone listings stored on the removable memory media. When advertisements are linked to business telephone listings stored on the removable memory media, they will appear on the display monitor as display advertisements when the user either conducts a search on the EDP for companies using the keyboard or accessing the business directory interface, or connects to another EDP on a telephone call within the same country or region. When a call is connected between a first party and a second party, if an advertisement stored on the removable memory media of the EDP of the first party is linked to the telephone number of the second party, the linked advertisement for the second party is displayed on the display monitor of the first party's EDP. For example, when a calling party places a call to a party having an EDP with a removable memory media which contains an advertisement linked to the calling party's telephone number, the advertisement linked to the calling party's telephone number is retrieved from the removable memory media of the EDP of the party receiving the call and displayed on the display monitor of the receiving party's EDP. When calling party places a call using an EDP having an advertisement linked to the telephone number being called, the linked advertisement for the party receiving the call is retrieved from the removable memory media of the calling party's EDP and displayed on the display monitor of the calling party's EDP.

Each EDP includes an activation code feature which requires that an EDP activation code be reset on a periodic basis, at predetermined time intervals, preferably every year. A series of activation codes are stored in memory of the EDP, with each activation code sequentially corresponding to a particular year in which the EDP will be used. Each series of activation codes is different for each EDP. The activation code for the EDP is reset each year to a different one of the series of activation codes. A current year activation code from the series of activation codes must be entered by the user at the beginning of a one year cycle for the EDP to be activated for the current year. The removable memory media includes a data storage field in which the current year EDP activation code is written for registering the removable memory media for use with the particular EDP. The removable memory media is preferably replaced each year with a removable memory media having current directory listings and scheduled advertisements for the year. The EDP also includes games, a calendar, an appointments reminder function, a prayer time function, and a direction to Qa'aba-Qebla function. Removable memory media may also include a dictionary, a thesaurus, an encyclopedia, a language translator, and the like.

### DESCRIPTION OF THE DRAWINGS

For a more complete understanding of the present invention and the advantages thereof, reference is now made to the following description taken in conjunction with the accompanying Drawings in which FIGS. 1 through 23 show various aspects for an electronic directory and advertising telephone (“EDP”) made according to the present invention, as set forth below:

FIG. 1 is a frontal perspective view of and the EDP;

FIG. 2 is a top view of the EDP;

FIG. 3 is a flow chart which shows the process for activating the EDP;

FIG. 4 is a flow chart depicting the EDP determining whether an SD card inserted into the EDP is capable of being used by the EDP;

FIG. 5 is a flow chart depicting insertion at a new SD card into the EDP;

FIG. 6 is a flow chart depicting the resetting of the activation code for the EDP at the end of a one year duration after the EDP is initially activated;

FIG. 7 is a block diagram depicting a user accessing a main interface of the EDP;

FIG. 8 is a flow chart depicting operation of the EDP;

FIG. 9 is a block diagram depicting the user accessing the EDP browser function to browse information listed in the database stored on an SD card;

FIG. 10 is a block diagram depicting the user using the search by company name interface to access detailed company information;

FIG. 11 is a block diagram depicting the user using the search by product name interface to locate and display detailed information regarding a product;

FIG. 12 is a block diagram showing the main phone menu of the EDP;

FIGS. 13a and 13b are block diagrams which together depict a user using the telephone main menu interface of the EDP;

FIG. 14 is a block diagram depicting use of the appointment interface of the EDP;

FIG. 15 is a flow chart depicting operation of the EDP for providing appointment reminders;

FIG. 16 is a flow chart depicting operation of the registered call notes function of the EDP;

FIG. 17 is a flow chart depicting operation of the EDP for displaying information related to a telephone number identified as having display information stored in the SD card database;

FIG. 18 is a block diagram depicting use of the received calls interface of the EDP;

FIG. 19 is a block diagram depicting use of the phonebook interface of the EDP;

FIGS. 20a and 20b together are a block diagram which describes use of the general interface of the EDP;

FIG. 21 is a block diagram depicting an other function interface for the EDP;

FIGS. 22a and 22b together provide a block diagram depicting use of a control panel interface of the EDP; and

FIG. 23 is a flow chart depicting an EDP screen saver function to display advertisements when the EDP is not in use.

### DETAILED DESCRIPTION OF THE INVENTION

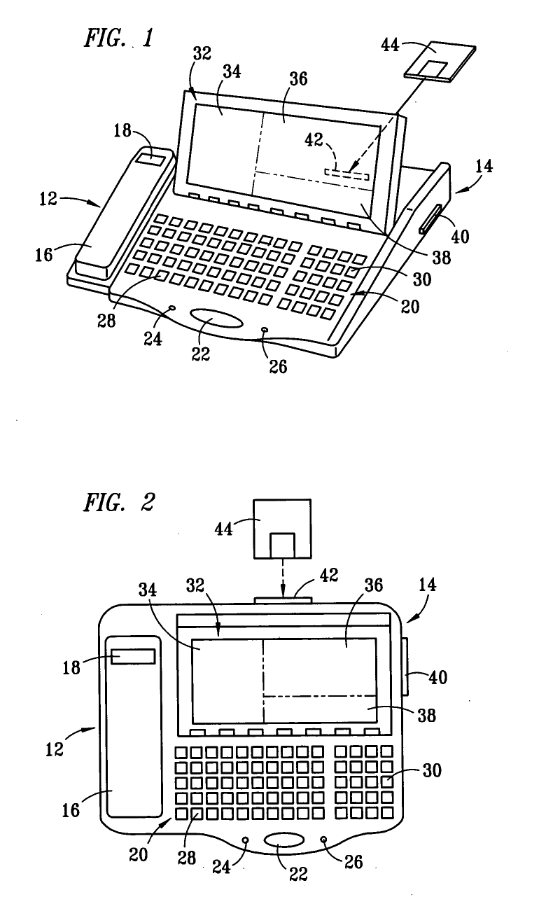

Referring to the Figures, FIG. 1 is a frontal perspective view and FIG. 2 is a top view of an electronic directory and advertising telephone 12, hereinafter referred to as an “EDP.” The EDP 12 has a base 14 and a handset 16. The handset 16 provides a voice conversion device for receiving and transmitting voice signals, and has an L.E.D. display 18 for displaying caller I.D. information, regarding a calling telephone number, the name and advertisements associated with the telephone number, if available. The base 14 includes keyboard 20, a pointing device 22, and selection buttons 24 and 26. The keyboard 20 includes an alpha keypad 28 and a numeric keypad 30. A flat screen display monitor 32 is pivotally mounted to the EDP base 14, and preferably has a hinge clutch mechanism (not shown) or a support stand (not shown) which will maintain the display monitor 32 in a vertically disposed, upright position when moved from a horizontal position. When in the horizontal position, the display monitor will lay flat upon upper side of the base 12. The display monitor is divided into a plurality of display regions, or display sections, 34, 36 and 38. A video game interface 40 is provided, preferably by a parallel port connector, for connecting video game controllers to the EDP 12. A removable storage media interface 40 is provided by a card slot 40, which includes a connector for electrically connecting a removable media 42 to the EDP 12. The removable memory media 44 is preferably provided by an SD card. It should be noted that the term removable memory media herein refers to data storage media which is readily removable by a user from the EDP 12, such as an SD card, and as opposed to electronic components and other storage devices which are considered more permanently mounted to circuit boards and such within the EDP 12.

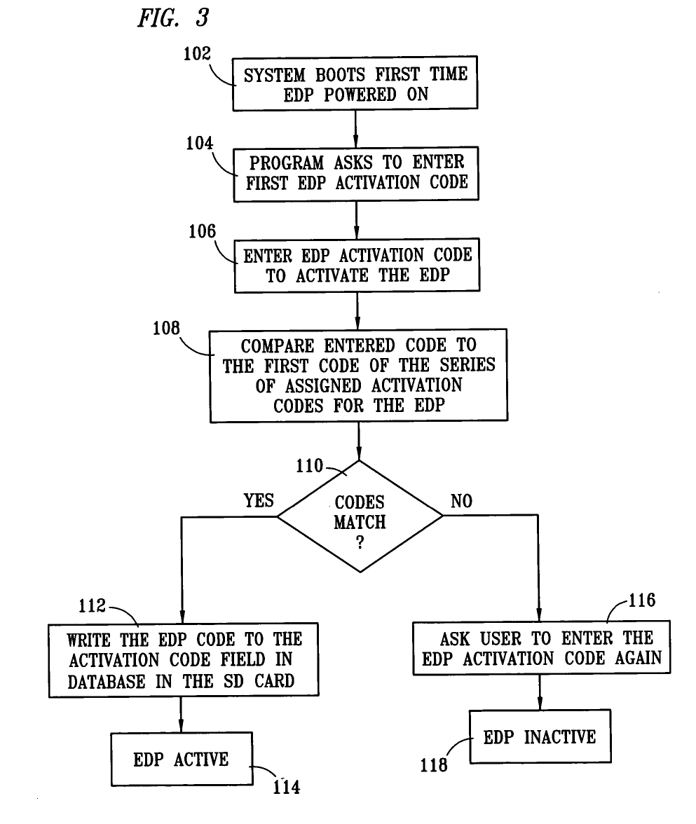

FIG. 3 is a flow chart which shows the process for activating the EDP 12 by entering the EDP activation code. It should be noted that when the EDP 12 is manufactured, a special series of EDP activation codes are assigned to a particular EDP 12, each EDP 12 having a different series of activation codes which is stored in data storage of the respective EDP 12, preferably in permanent memory onboard the EDP 12 rather than in removable memory media. Each activation code of the series is preferably for a particular term of operation of the EDP 12, requiring activation a periodic basis. The terms are preferably approximately one year in duration, and fifty activation codes are preferably provided in the series such that the EDP 12 may be activated on a periodic basis, such as at a particular date each year, for up to 50 years. In step 102 the EDP 12 operating system boots the first time the EDP 12 is powered on. Then in step 104 the program asks the user to enter a first EDP activation code for the current year. In step 106 the user enters the EDP activation code for the current year, and then in step 108 the EDP compares the entered activation code to the first code of the series of assigned activation codes for the EDP 12. Step 110 is where the EDP 12 determines whether the entered code matches the first of the series of assigned activation codes for the EDP 12. If the codes match, then the EDP 12 proceeds to step 112 and writes the EDP activation code to the activation code field in the database in the SD card. Prior to activation in an EDP 12, a new SD card will not have any data in the activation code field, that is, the field will be blank. Then, if the correct activation code is entered into the EDP 12 to match the first code in the series of codes, the EDP 12 will be active, as depicted in step 114. If in step 110 it is determined that the code entered by the user does not match the first of the series of assigned activation codes for the EDP 12, then the EDP will prompt the user to enter the EDP activation code again in step 116. Step 118 depicts the EDP 12 being made inactive, until the user enters the proper EDP activation code which matches the first of the series of activation codes assigned to that particular EDP 12.

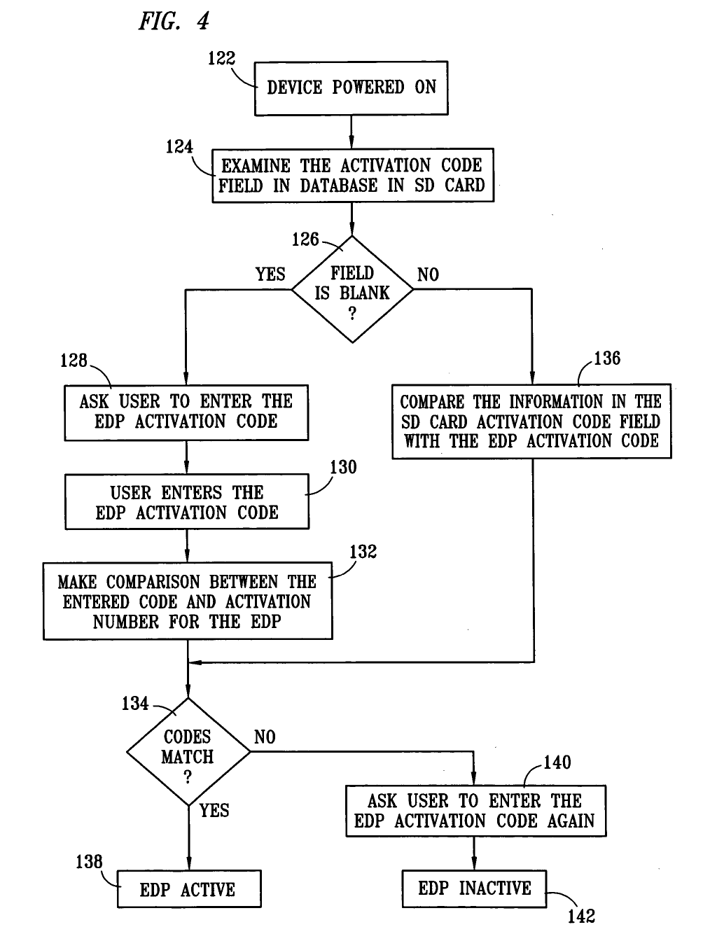

FIG. 4 is a flow chart depicting the EDP 12 determining whether an SD card inserted into the EDP 12 is capable of being used by the EDP 12, by whether it has been registered for use with the EDP 12. Step 122 depicts the EDP 12 being powered on. In step 124 the EDP 12 examines the activation code field in the database in the SD card. In step 126, a determination is made as to whether the activation code field in the SD card database is blank. If the SD card activation field is blank, the process proceeds to step 126 in which the EDP 12 asks the user to enter the EDP activation code. In step 130 the user enters the EDP activation code. In step 132 a comparison is made between the entered code and the activation code for that particular EDP 12. If in step 134 it is determined that the codes match, the process proceeds to step 138 and the EDP 12 is made active. If the codes do not match, step 140 depicts the EDP 12 asking the user to enter the EDP activation code again. Step 142 depicts the EDP 12 being made inactive if the correct EDP activation code is not entered. Returning to the decision block depicting step 126, if the activation field in the database in the SD card is not blank, the activation code in the SD card activation field is compared with the current year activation code for the EDP 12 in step 136. If it is determined in step 134 that the activation code in the SD card database matches the EDP activation code for the current year, the EDP 12 is made active as shown in step 138. If the codes in the activation code field of the database in the SD card does not match current year activation code for that particular EDP 12, the process proceeds to step 140 and asks the user to enter the EDP activation code again, and in step 142 the EDP 12 is made inactive.

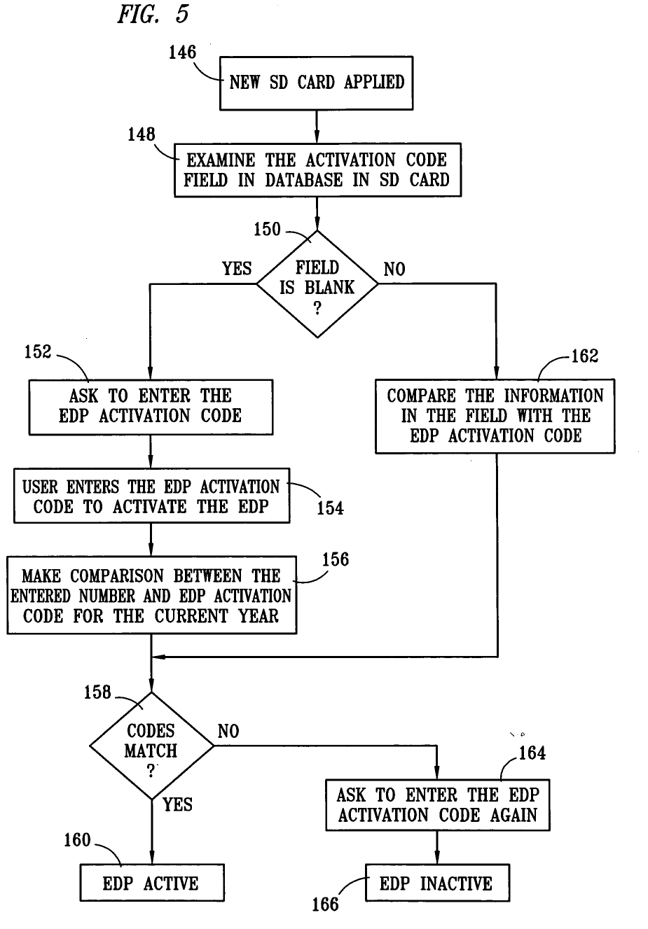

FIG. 5 is a flow chart depicting insertion of a new SD card into the EDP 12. In step 146 a new SD card is inserted into the EDP 12. In step 148 the EDP 12 examines the activation code field in the database of the SD card. In step 150 a determination is made of whether the activation code field in the SD card database is blank. If the field is blank, in step 152 the user is asked to enter the EDP activation code for the current year into the EDP 12. In step 154 the user enters the EDP activation code for the current year, and comparison is made between the entered code and current EDP activation code, which is the first of the series of activation codes for the particular EDP 12 being used. If the codes match as determined in step 158, the process proceeds to the step 160 and the EDP 12 is active. If in step 150 the activation code field in the SD card is not blank, the process proceeds to step 162 in which the information in the activation code field of the SD card is compared with the EDP activation code. If the codes match as determined in step 158, the process proceeds to the step 160 and the EDP 12 is active. If the code found in the activation code field of the SD card database does not match the current year of EDP activation code, the user is asked to enter the EDP activation code again in step 164. In step 166 the EDP 12 is inactive.

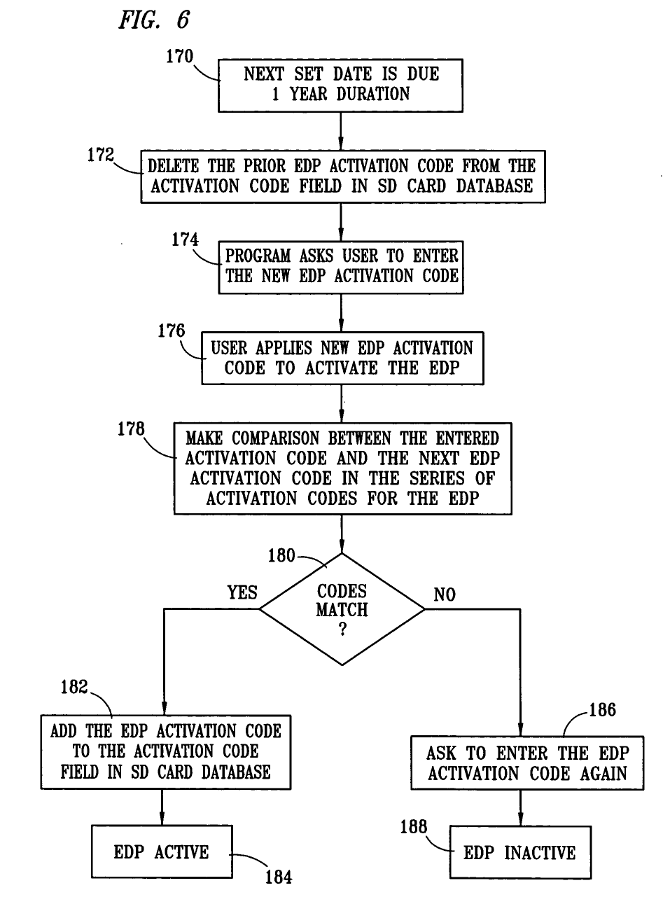

FIG. 6 is a flow chart depicting the resetting of the activation code for the EDP 12 at the end of a one year duration after the particular EDP 12 is initially activated. As previously discussed, each EDP 12 has a series of codes entered into the EDP 12 during manufacturing, which are sequentially used for entering into an activation code field in an electronically stored database in the EDP 12. Each of the codes in the series of codes is used for the EDP activation code for one year. The first code in the series of activation codes is used for one year, and then at the end of one year the code is deleted from the database of the EDP 12. Then, the next code in the series of EDP activation codes becomes the first code remaining in the series, and is used as the current year EDP activation code for the next year. EDP activation codes are different for each EDP 12, and allow the manufacturers of the EDP 12 to assure that unauthorized use cannot be made at EDP 12 and to protect the databases released on the SD cards on an annual basis. In some embodiments, the EDP activation codes are reactivated every twelve months after initial activation of a particular EDP 12. In other embodiments, various EDPs are set for activation codes to expire on particular dates of the year, such that, for example, all EDPs in a particular geographic region will require activation at the same time of year when SD card containing new databases for the geographic region are scheduled for release.

Step 170 depicts the EDP 12 detecting that the activation code set date is due, and then resetting the set date for a one year duration. Step 172 depicts deleting the prior EDP activation code from the activation code field in the SD card database. Step 174 depicts the program asking the user to enter the new EDP activation code, for comparison with the first code in the series of EDP activation codes. In step 176 the user applies the new EDP activation code to activate the EDP 12. In step 178 a comparison is made between the entered activation code and the current year EDP activation code, which is now the first in the series of activation codes for the particular EDP 12 since the activation code in the series for the previous year has been deleted from the series. In step 180 it is determined whether the entered code matches the EDP activation code for the current year. If the entered code matches the current year EDP activation code, as determined in step 180, the process proceeds to step 182 in which the current year EDP activation code is added to the activation code field in the SD card database. In step 184 the EDP 12 is made active, and is operational. If in step 180 it is determined that the user entered code does not match the current year EDP activation code, in step 186 the user is asked to enter the EDP activation code again. If the entered code does not match the current year activation code for the EDP 12, the EDP 12 is made inactive in step 188.

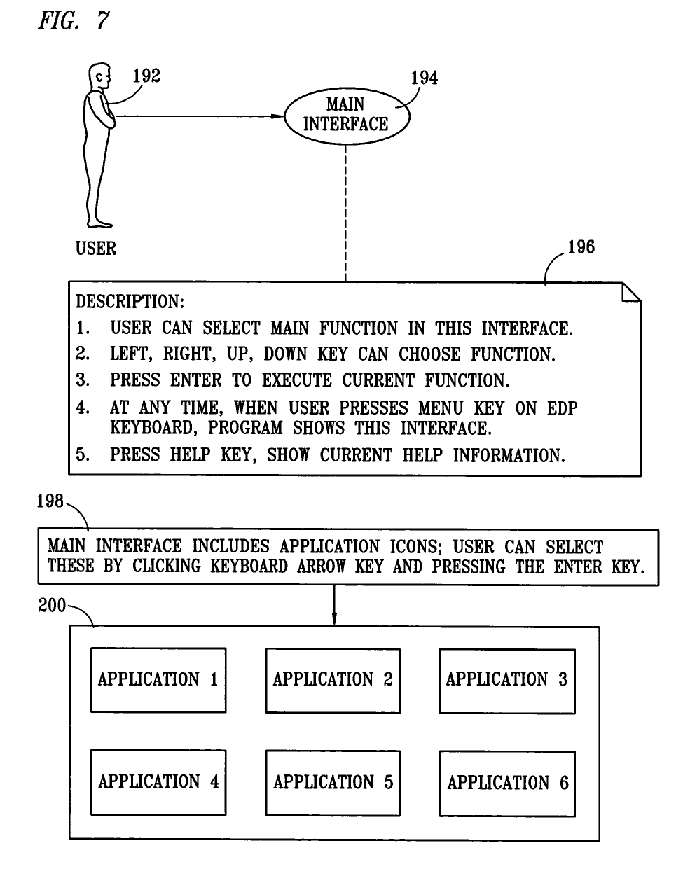

FIG. 7 is a block diagram depicting a user 192 accessing the main interface 194 of an EDP 12. Block 196 describes that the user can select the EDP function in the interface 194. Block 198 represents that the EDP function is preferably selected using the keyboard 20, with the left, right, up and down direction keys being used to highlight one of the icons representing the various functions as listed on the display monitor 32. Once a desired EDP function icon is highlighted, then the user may press the enter key to execute the currently highlighted function as selected by using the various direction keys. The EDP 12 has a menu key which at any time the user may press to show the main interface 194. Block 200 represents a display of the main interface 194, which includes application icons representing the main EDP functions which the user selects to initiate one of the various EDP applications.

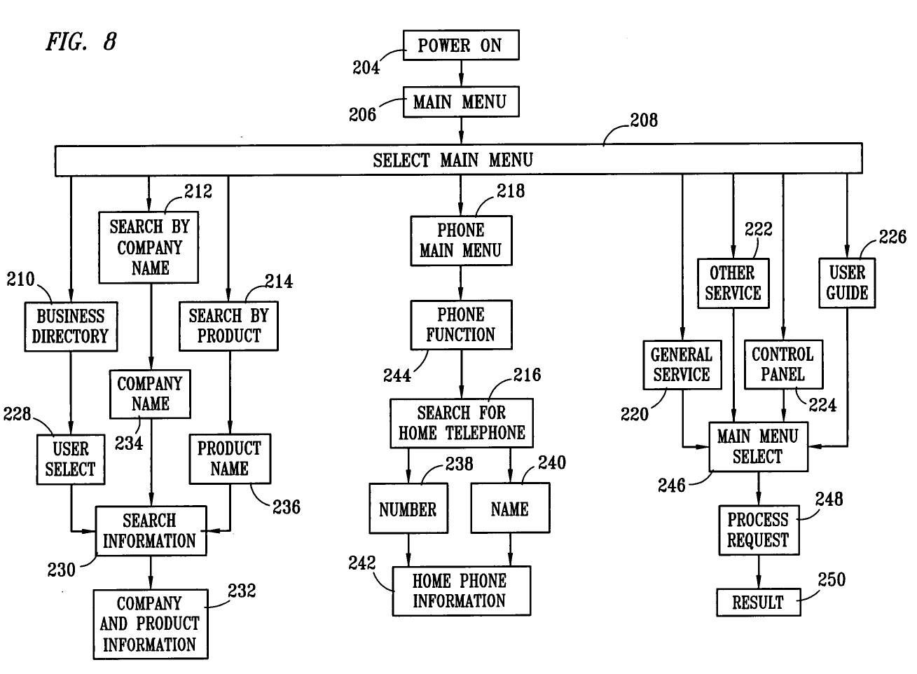

FIG. 8 is a flow chart depicting operation of the EDP 12. In step 204 an EDP 12 is powered on and in step 206 the main menu is displayed. Once the main menu is displayed in step 208, the user may select which EDP function to initiate. These EDP functions include various search techniques to locate a particular directory listing. These EDP functions include a business directory which may be selected in step 210, a search by company name function which may be selected in step 212, a search by product function which may be selected in step 214, a search for home telephone number function which may be selected in step 216, a phone main menu function which may be selected in step 218, as general service information function which may be selected in step 220, an other services function which may be selected in step 222, or to access the user's guide function in the step 226. If the user selects the business directory function in the step 210, the user will select various parameters for correlation to business types in step 228, and then in step 230 the EDP 12 performs a search of information in the SD card database according to the parameters selected in the step 228. In step 232 the results of the search are displayed in the form of company and product information. If the user selects the search by name feature in step 212, the user will enter a company name in step 234 and a search of the database on the SD card is performed in the step 230. In step 232 the company and product information is displayed for the companies which match the search parameters entered in the step 234. If the user selects to search for by product in step 214, then the user enters the product name in step 236. The EDP 12 searches the information in the SD card database in the step 230, and then the search results are displayed as company and product information in the step 232. If in step 218 the user selects the phone main menu, the various phone functions of the EDP 12 are displayed in step 244. The user may select to search for home telephone numbers in step 216, then the user may enter either the number in step 238 or the name of the person for whom the home search is directed in step 240. The EDP 12 then searches the SD card database and displays the relevant name and home phone information in the step 242. If the user selects general services in step 220, the main menu function is selected in step 246. Step 246 will then access different requests for process in step 248 and results will be displayed in step 250. If the other services are selected in step 222, a main menu function is selected in the step 246, the request is processed in the step 248, and results are displayed in the step 250. If a control panel function is selected in step 224, the main menu function select is in the step 246, the request is processed in the step 248 and results are displayed in the step 250. The user may also select the user guide in step 226, which again a main menu function will be selected in the step 246, the request is processed in the step 248 and results displayed in the step 250.

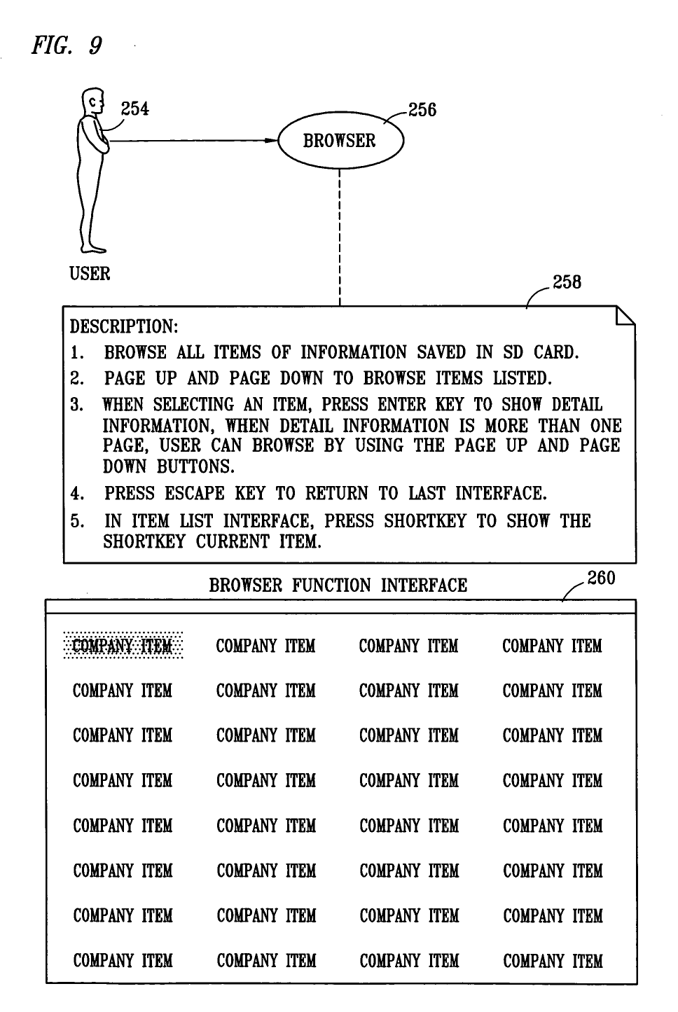

FIG. 9 is a block diagram depicting the user 254 accessing the EDP browser function 256 to browse information listed in the database stored on an SD card. Block 258 describes the user controls for operating the EDP 12 in browser mode using the direction keys, the enter key, the page up and the page down keys, and the escape key of the EDP keyboard 20. The user used the direction keys to highlight directory and item listings, and then presses the enter key to see details relating to a highlighted listing. If the displayed information is more than one page, the user may use the page up and page down keys to browse the various pages. Block 260 depicts an example of a display screen, and shows one of the listed company items highlighted. Once the user selects the listed item, the enter key may be pressed to show detailed information the selected listing. In the example of block 260, once the company item is selected the enter key may be pressed to show various details of the listed items. In some entries, further listings may be nested within the detail listings which may be highlighted by the user and the enter key pressed to display further details. The user may press the escape key on the EDP keyboard 20 to return to the last displayed interface listing, or menu. The user may also select an item in the list interface depicted in the block 260, and press one of the shortcut keys on the EDP keyboard 20, such that the user may later directly access the relevant information for the selected item by pressing the shortcut key on the keyboard 20, without having to move through the browser interface. A shortcut may also be displayed as an icon on the display monitor 32, such that the user will point to or highlight the shortcut to access the information for selected item.

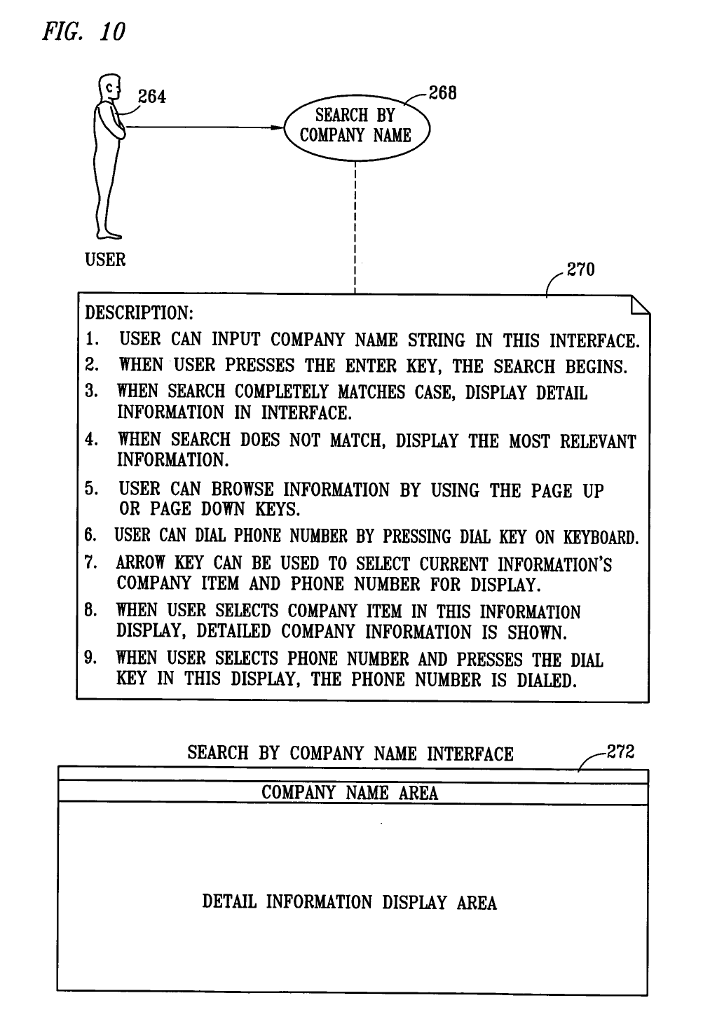

FIG. 10 is a block diagram depicting the user 264 using the search by company name interface 268 to access detailed company information, as shown in the block 272. Block 270 describes the various actions the user may take in performing a search by company name. The user can input company name search strings in this interface, such as a search string using various terms relating to a company name the user wishes to locate in the SD card database. The enter key is presses to execute the search. When the search is completed and finds a matching company, the detail information corresponding to company is displayed as depicted in block 272. When an exact match is not found in the SD card database, listings of the most relevant company names and information corresponding to the most relevant companies are displayed. The user can then browse the displayed information by using the keyboard direction keys, or the page up and page down keys. Once information for a company is displayed, the user can dial a phone number for the company by pressing the dial key on the keyboard 20. When the user selects the product display information for a selected company, detailed product information is shown on the EDP display 32. When the user selects to display the phone number and presses the dial key, the displayed phone number is automatically dialed.

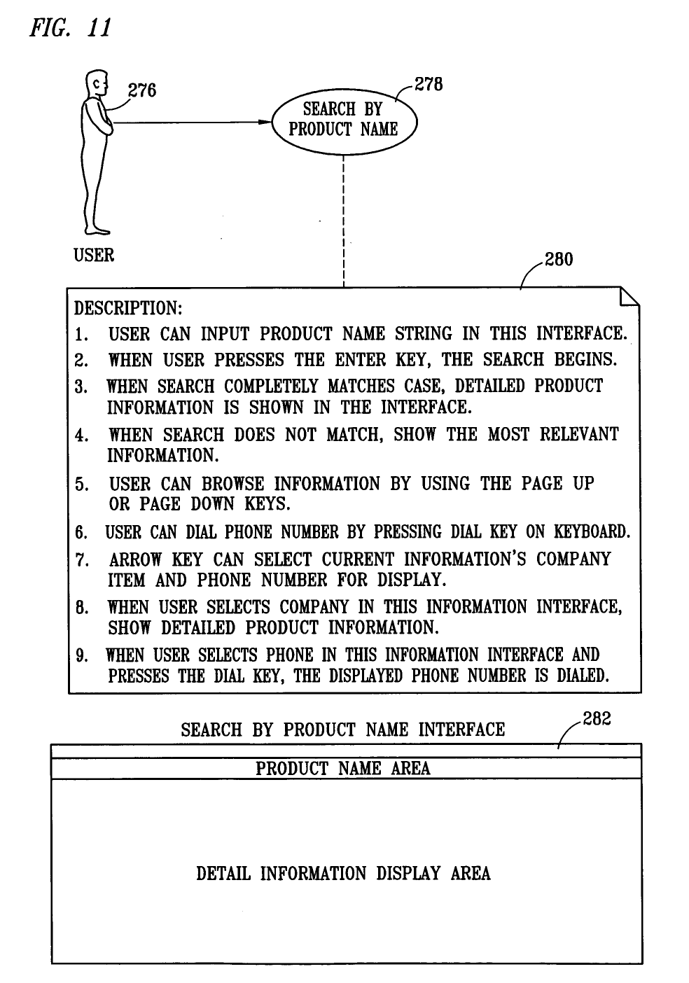

FIG. 11 is a block diagram depicting the user 276 using the search by product name interface 278 to locate and display detailed information regarding a product as depicted in the block 282. Block 280 describes the various methods of using the product search by name feature 278. The user can input a product name search string in the search by product name interface 278. When the user presses the enter key, the search is executed. When a product matching the search string is found, detailed product information is displayed as depicted in the block 282. When an exact match is not found, information regarding the most products matching the search string is displayed. The user can browse the information displayed using the keyboard direction keys, or the page up and the page down keys. A phone number listed with the displayed product information can be dialed by pressing the dial key on the keyboard 20. The direction keys can be used to select current information for the company listed for the product, and the company's directory listing and phone number will be displayed. When the user selects a particular company listed in the product name search, the EDP 12 will displayed detailed product information for the company. It should also be noted, that in any of the EDP interfaces, the user may select a phone number by highlighting the number and then pressing the dial key will dial the selected phone number.

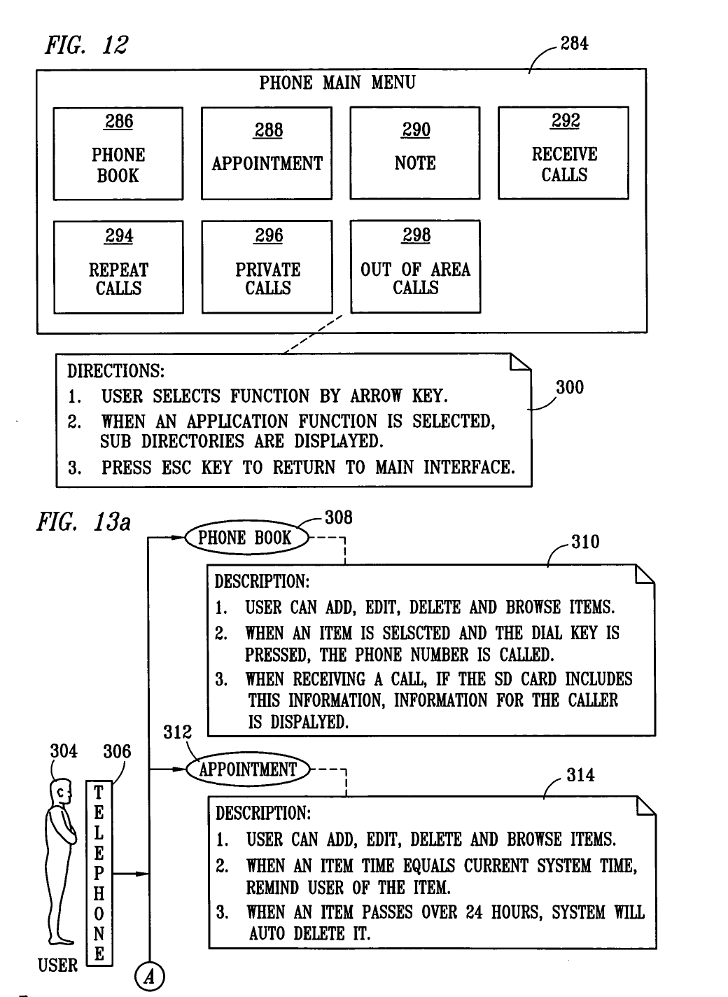

FIG. 12 is a block diagram showing the main phone menu 284. The main phone menu 284 displays icons for a phone book function 286, an appointment function 288, a note function 290, a received calls function 292, a repeat calls function 294, a private calls function 296, and an out of area calls function 298. The block 300 describes user operation to select between the various functions of the main phone menu 284. The user first selects the function by highlighting the function with the keyboard direction keys, and then pressing the enter key display subdirectories under the particular function. When the escape key is pressed, the application will return the user to display the main interface menu. As described above, if a phone number is highlighted, pressing the dial key will dial the phone number.

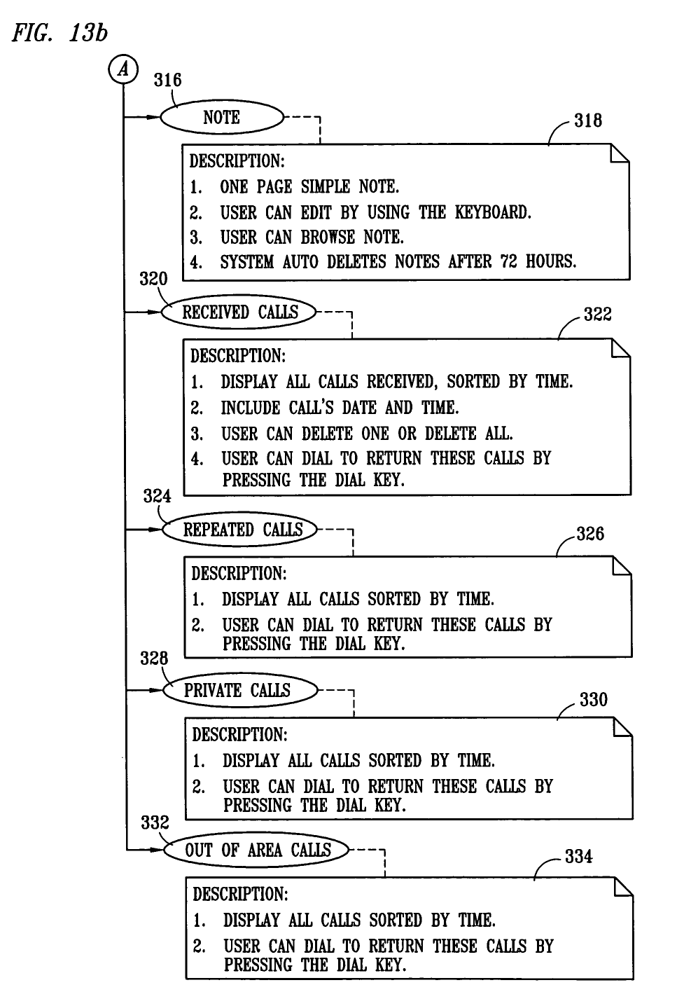

FIGS. 13a and 13b are block diagrams which together depict a user 304 using the telephone main menu interface 306 of the EDP 12. When the phone book function 308 is selected, block 310 depicts the user can add, edit, delete and browse various items listed in the phone book. When the user selects an item and presses the dial key, the phone number is dialed for the corresponding item. That item may be a company, an individual, or other organization having a phone number which the user desires to dial. When a call is received, if the SD card database includes information for the caller, the information for the caller is displayed. The information may be a map showing the location of the caller, an advertisement for the caller, or a graphic display, such as a picture of the caller if an individual. The advertisements will also typically include a graphic display for the caller. If the appointment function 312 is used, block 314 describes operation of the user to use the appointment function 312. In the appointment interface, the user can add, edit, delete, and browse various items listed in the appointment interface. When an item time equals a current system time, the EDP 12 will remind the user of the pending item. When the item time passes over 24 hours old, the EDP 12 will auto delete the item. When the notes function 316 is accessed, block 318 describes operation of the notes interface 316. The notes are preferably one page simple text notes the user can edit using the keyboard 20. The user can also browse the various notes. The EDP 12 will auto delete the notes after 72 hours, if the auto delete feature is selected. The received calls interface 320 is operated according to the various steps depicted in block 322. When the received calls interface 320 is selected, the calls received are shown, preferably sorted by the date and time at which they were received. The user can select to delete one received call record at a time, or can select to delete all received call records at one time. The user can also select the received calls listing, and then return the dial the listed phone number by pressing the dial key. A repeated calls interface 324 may be selected, and operated according to the steps set forth in the block 326. Repeated calls shows all calls which are received more than once, sorted by date and time. The user can dial to return calls suing the numeric keypad 30, or may return the calls by highlighting the call to select the call and then pressing the dial key. The private calls interface 328 is operated according to the steps set forth in the block 330. All private calls are shown sorted by date and time. The user can dial these calls by highlighting the calls using the keyboard direction keys and then pressing the dial key. The out of area calls interface 332 is operated according to the steps shown in block 334. All listed out of area calls are sorted by date and time. The user can return the out of area calls by highlighting the number and pressing the dial key.

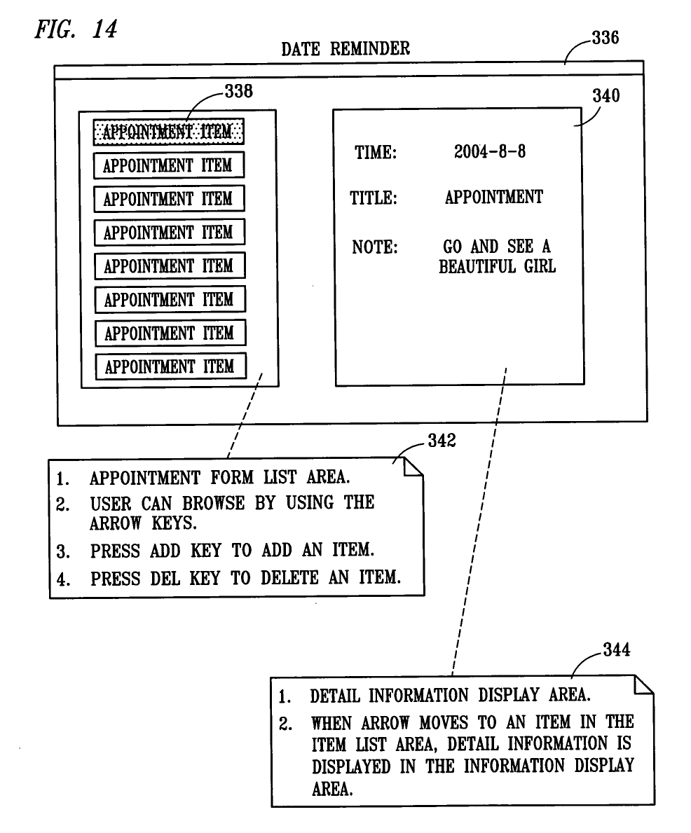

FIG. 14 is a block diagram depicting use of the appointment interface 336. A listing of various appointment items are displayed in a list area 338, as shown on the left side of the interface 336. As an appointment item in the list area 338 is selected for viewing, and details regarding the selected appointment are displayed in the display area 340, as shown on the right side of the display interface 336. Block 342 describes operation to review the appointment interface 336 when a user selects an EDP mode of operation in which that highlighted appointments in the list area 338 are automatically displayed in the detail area 340. The user can browse by various list items using the direction keys, and the page up and page down keys, of the keyboard 20 to select various ones of the items listed in the list area 338. When an appointment item is selected, the program will automatically show the item details on the right display area. An add key on the keyboard 20 may be pressed to add an item and the delete key may be pressed on the keyboard 20 to delete an item which is highlighted. Block 344 describes operation to review the appointment interface 336 when a user selects an EDP mode of operation in which details of an appointment item highlighted in the list area 338 are automatically displayed in the detail area 340. In the mode of operation according to block 344, the user selects a listed item in the list area 338 by highlighting the item using the keyboard direction keys, or the keyboard page up and page down keys, and the detail information display area 340 will change to display information for selected items as the directions keys are used to move through the items listed in the list area 338.

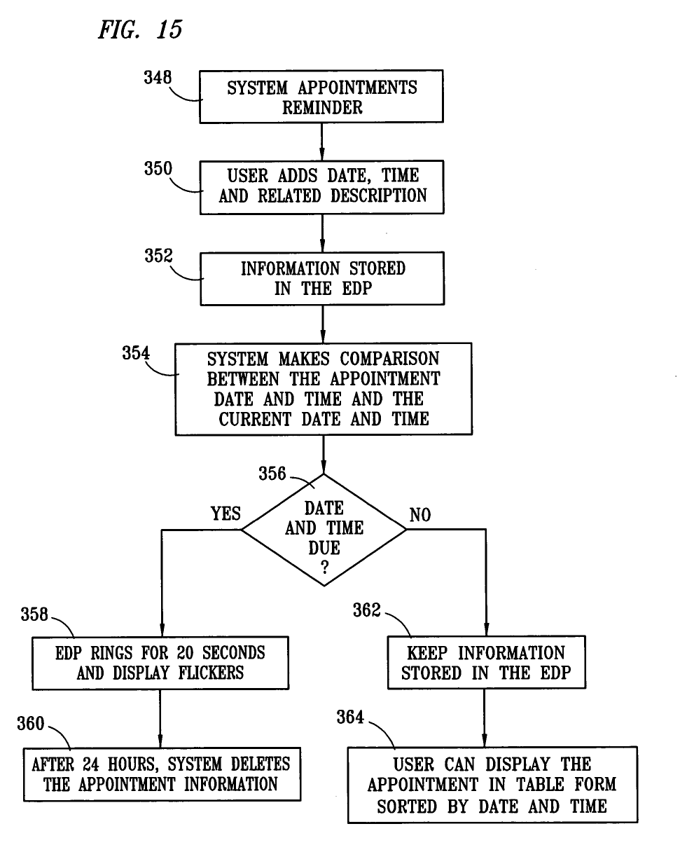

FIG. 15 is a flow chart depicting operation of the EDP 12 for providing various appointment reminders. In step 348 the appointment reminder interface is selected. In step 350 the user adds date, time, and related description information for a particular appointment reminder. In step 352 the information is stored in the EDP 12, preferably by writing the information to the SD card database. During operation of the EDP 12, the appointment date and time are compared to the current date and time in step 354. If in step 356 it determines that a date and time are due when the appointment date and time matches the current date and time. In step 358 the EDP 12 rings for 20 seconds and the display screen flickers. In step 360 the EDP 12 automatically deletes the appointment information twenty-four hours after the appointment time. If the date and time do not match between the appointment date and time, and the current date and time, the appointment information remains stored in the EDP 12, preferably in the SD card database, and in step 364 the user can display the appointment in table format sorted by date and time.

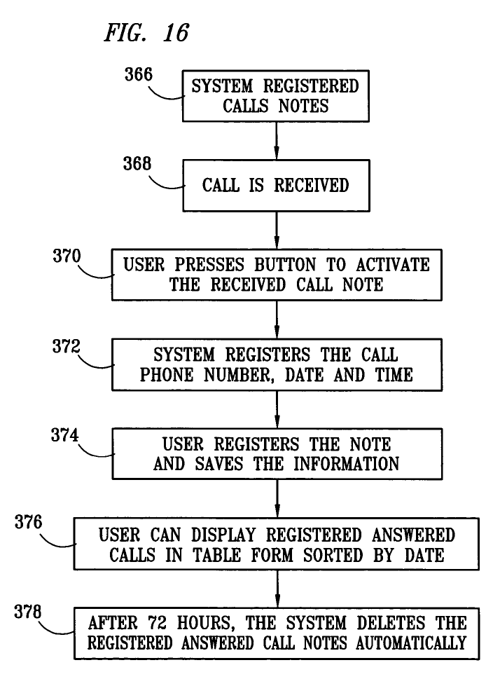

FIG. 16 is a flow chart depicting operation of the registered call notes function of the EDP 12. In step 366 the user will select a system registered call notes interface. A call is received in the step 368, and then the user may press a call notes button on the keyboard 20 to activate the received call note function in step 370. The EDP 12 will then register the call phone number, date, and time in step 372, and then the user may enter a note that corresponds to the received call in the step 374. The user can later display registered answered calls in a table format sorted by date in step 376. In step 378 the EDP 12 deletes the registered answered call notes automatically after seventy-two hours, if the auto-delete feature is selected for the EDP 12.

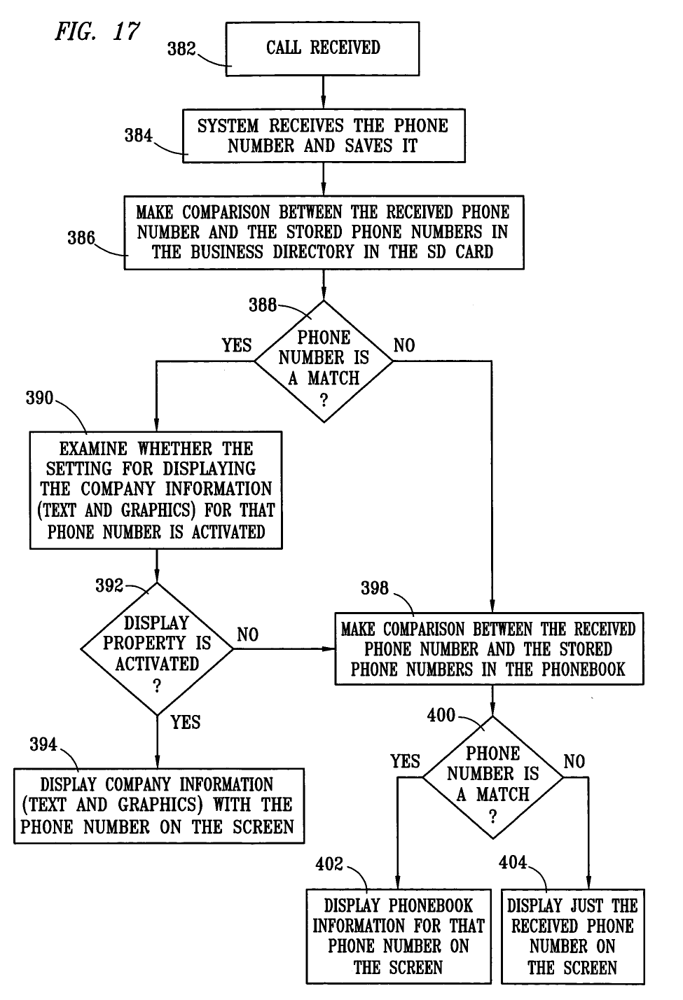

FIG. 17 is a flow chart depicting operation of the EDP 12 for displaying information related to a telephone number identified as having matching information or display information stored in the EDP memory, or stored in the SD card database. The call is received in the step 382. The EDP 12 receives the phone number and saves it in the step 384. A comparison is made between the received phone number and other phone numbers stored in the business directory in the SD card in step 386. In step 388 a determination is made whether the phone number matches a phone number stored in the business directory on the SD card. In step 390 the EDP 12 examines whether a display property stored in an SD card database field value for displaying company information such as text and graphics is activated for that phone number. In step 392 a determination is made whether the display property is activated for a particular phone number, and if so, the various company information, including text, graphics, company advertisements and the phone number are displayed on the EDP display monitor 32 in step 394. If in step 392 a determination is made that the display property stored in the SD card database field corresponding to the caller's phone number is not activated for the company information for the particular phone number, a comparison is made between the received phone number and the stored phone numbers in the EDP phone book in the step 398. If in step 400 it is determined that the caller's phone number is a match with a stored listing, then phone book information for that particular number will be displayed on the display screen in step 402. If the phone number is not a with a phone number in the EDP phone book only the received phone number is displayed on the EDP display monitor 32. If in the step 388 it is determined that the phone number is not a match to any of the phone numbers listed in the company directory, a comparison is made between the received phone number and the stored phone numbers in the phone book in step 398. If in the step 400 it is determined that the caller's number matches a number in the EDP phone book, the information corresponding to the phone number is displayed on the display monitor 32 in step the 402. If the phone number is not a match with the number in the phone book as determined in step 400, only the number of the caller is displayed. The EDP phone book may be stored in either internal memory in the EDP 12, or in the SD card database.

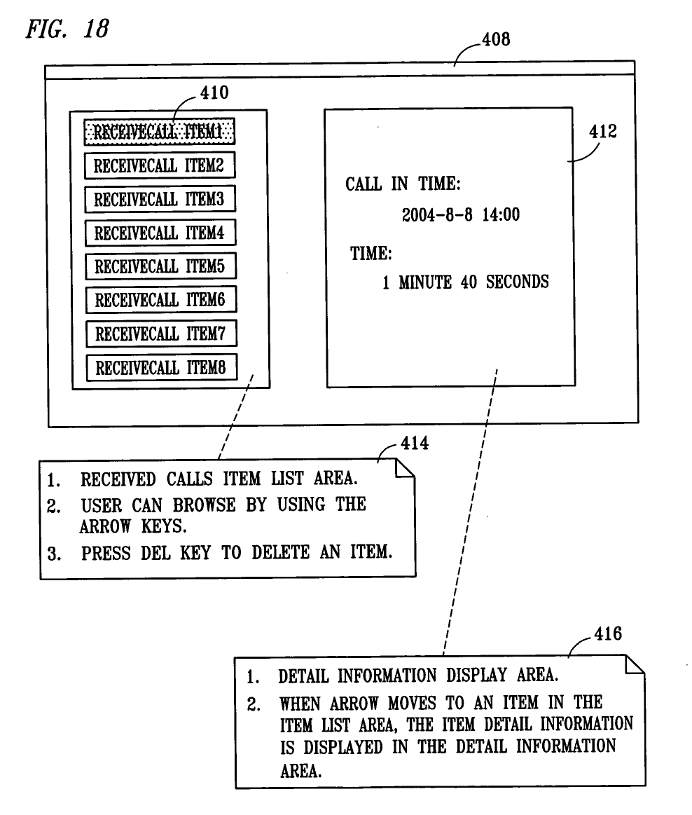

FIG. 18 is a block diagram depicting use of the received calls interface 408. Various received call items are displayed in a list area 410, as shown on the left side of the interface 408. A received call item in the list area 410 is highlighted, and details regarding the received call are displayed in the display area 412, as shown on the right side of the display interface 408. Block 414 describes operation to review the received calls interface 408 when a user selects an EDP mode of operation in which that highlighted received calls in the list area 410 are not automatically displayed in the detail area 412. The user can browse by through the various received call list items displayed in the list area 410 using the direction keys, and the page up and page down keys, of the keyboard 20 to select various ones of the items listed in the list area 410. When a received call item is selected in the list region 410, the program automatically shows the item details on the right display region 412. An add key on the keyboard 20 may be pressed to add a received call item to the list in region 412, and the delete key may be pressed on the keyboard 20 to delete a received call item which is highlighted. Block 416 describes operation to review call items in the received calls interface 408 when a user selects an EDP mode of operation in which details of a highlighted received call in the list area 410 are automatically displayed in the detail area 412. In the mode of operation according to block 416, the user selects a listed item in the list area 410 by highlighting the item using the keyboard direction keys, or the keyboard page up and page down keys, and the detail information display area 412 will change to display information for selected items as the directions keys are used to move through the items listed in the list area 410.

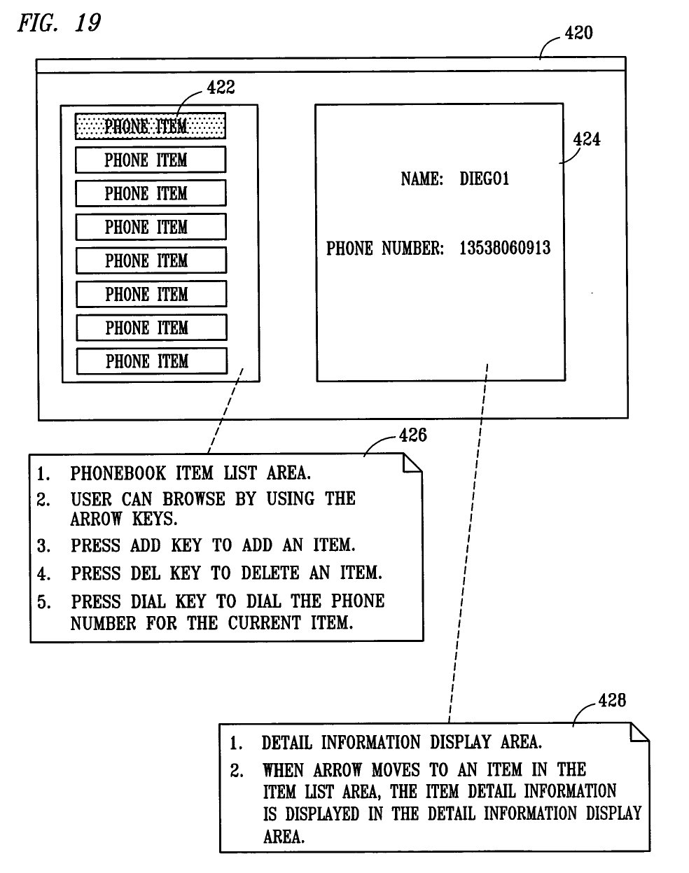

FIG. 19 is a block diagram depicting use of the phonebook interface 420. Various phone item listings, such as a phone number, or name associated with the phone number, are displayed in a list area 422 on the left side of the interface 420. A phone item listing in the list area 422 is highlighted, and details regarding the phone item are displayed in the display area 424, as shown on the right side of the display interface 420. Block 426 describes operation to review the phone item listings in the interface 420 when a user selects an EDP mode of operation in which that highlighted phone items in the list area 422 are not automatically displayed in the detail area 424. The user can browse by various phone items in the list using the direction keys, and the page up and page down keys, of the keyboard 20 to select various ones of the items listed in the list area 422. When an phone item is selected, a user may press the enter key to show the item details on the right display area 424. An add key on the keyboard 20 may be pressed to add a phone item, and the delete key may be pressed on the keyboard 20 to delete a phone item which is highlighted. Block 426 describes operation to review the phone items listed on the interface 420 when a user selects an EDP mode of operation in which that highlighted received calls in the list area 422 are automatically displayed in the detail area 424. In the mode of operation according to block 428, the user selects a listed item in list area 422 by highlighting the item using the keyboard direction keys, or the keyboard page up and page down keys, and the detail information display area 424 will change to display information for selected items as the directions keys are used to move through the phone items listed in the list area 422.

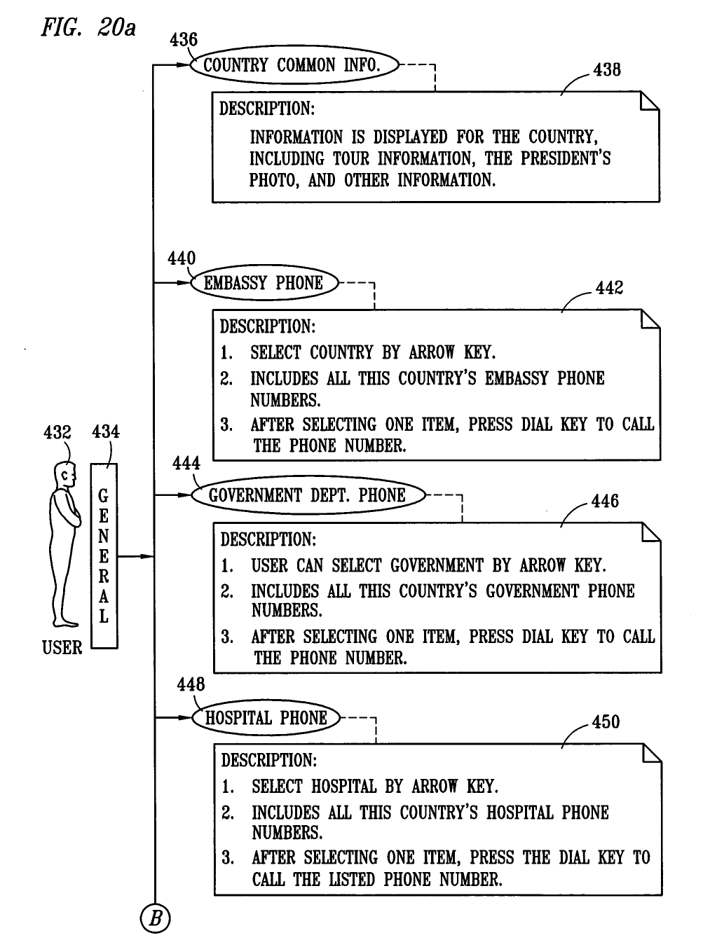

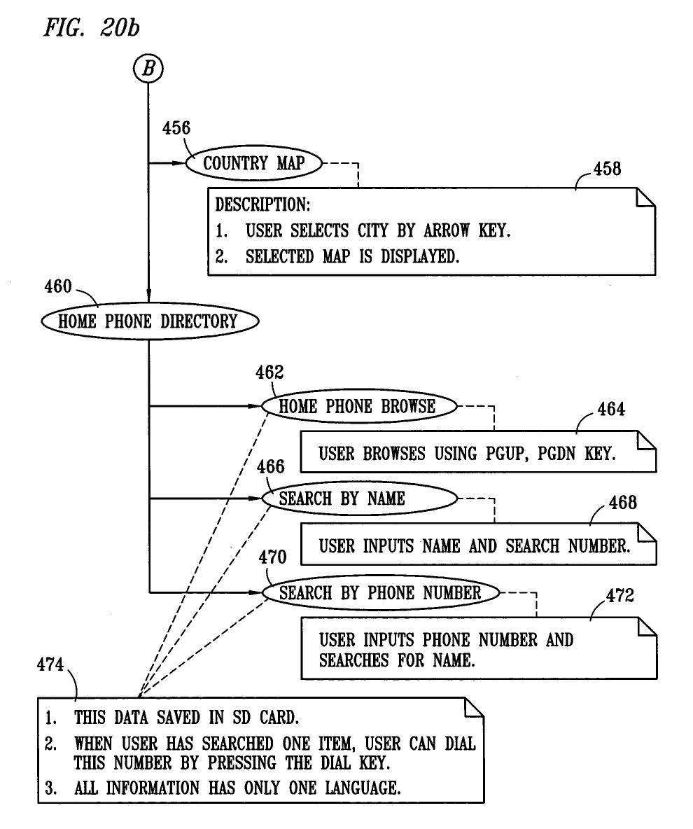

FIGS. 20a and 20b together are a block diagram which describes a user 432 using the general interface 434 of an EDP 12. When the country common information interface 436 is selected, the user can access the general interface 434 by pressing the enter key to display the country information, including tour information, the President's photo and other relevant information regarding the selected country. The embassy phone interface 440 may be selected, and used according to the steps set forth in the block 442. The user can select using a country by using the direction keys on the keyboard. When a country is chosen, all the country's embassy phone numbers are displayed. After choosing an item the user can press the dial key to call the selected phone number. A government department phone interface 444 may be selected and operated according to the steps set forth in the block 446. The user can select the government interface by use of the keyboard direction keys. A listing of all the country's listed government phone numbers will be displayed. After choosing an item, the user may press the dial key to dial the related phone number for the chosen government department. Similarly, the SD card database will list all the various hospitals in the particular locale corresponding to the directory listings in the SD card database. Hospital phone interface 448 may be used according to the steps set forth in the block 450 to determine information regarding the hospitals of a local area. Hospitals may be selected by using the direction keys on the keyboard. This will list all the country's hospitals, and corresponding phone numbers. After choosing one of the listed hospitals, the user may press the dial key to call the phone number listed for the corresponding hospital.

The user may also use the country map interface 456 according to the block 458. The user selects a city using the direction keys on the keyboard 20. Then, a selective map for a corresponding city is displayed. The user may also use the home phone directory interface 460 for calling home phone numbers of selected persons. The user may select home phone browse interface 462 then the user browses the home phone directory listings using either the keyboard direction keys or the page up and page down keys. The user may use the search by name feature 466, by which the user inputs the name and then searches for a phone number corresponding to the name according to the steps depicted in block 468. The user may also access the search by number interface 470, in which the user inputs the phone number and then searches for a name corresponding with phone numbers as depicted in block 472. Preferably, phone book an home telephone numbers are stored in the SD card database, and entries may be added to the SD card database by the user. When the user finds a desired listing, the telephone number corresponding to the listing may be dialed by pressing the dial key.

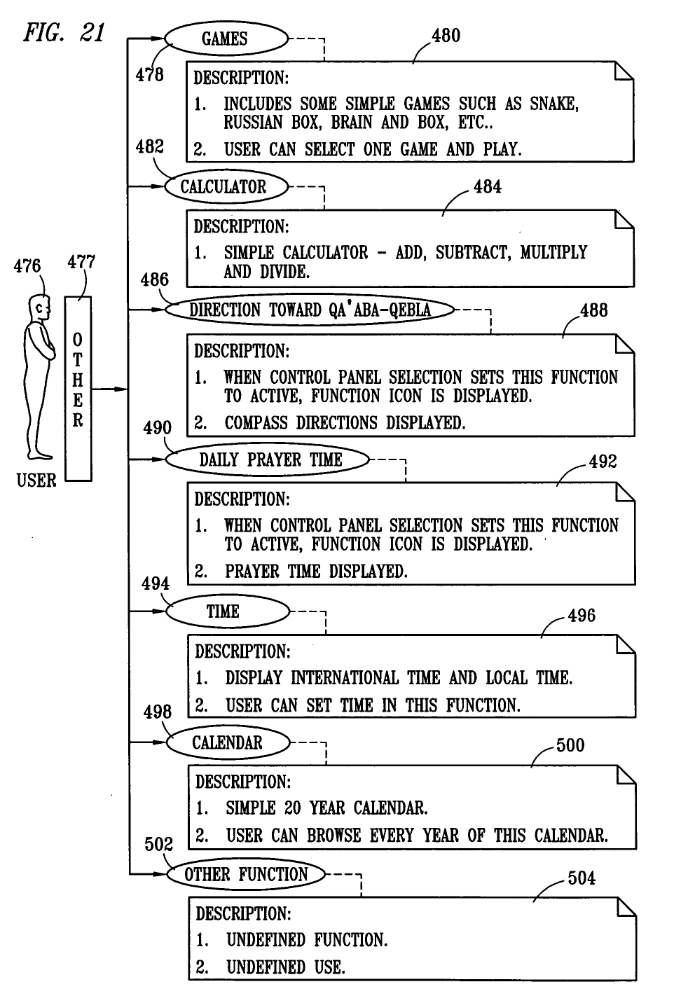

FIG. 21 is a block diagram which depicts a user 474 accessing the other interface 476 for the EDP 12. The other interface 476 includes a games interface 478, a calculator interface 482, a direction toward Qa'aba-Qebla display function 486, a daily prayer time function 490, a time interface 494, a calendar function 498, and an other functions interface 502. The games interface 478 is operated according to the block 480, and includes a collection of simple games which may be selected for a user to play. The user simply highlights a game icon and presses the enter key to select one of the games. In the calculator interface 482, simple calculations functions may be performed, as listed in block 484. These simple calculator functions include addition, subtraction, multiplication, and division. In other embodiments of the EDP 12, more robust calculator functions may be included, such as those directed toward accounting, statistical and scientific calculations. The Qa'ab-Qebla direction display function 486, when set to active, displays the direction towards Qa'ab-Qebla on the display monitor 32. Block 488 describes the direction toward Qa'ab-Qebla as being an icon, or other graphical display, appearing on a portion of the display monitor 32 which shows the compass heading towards Qa'ab-Qebla, at Mecca. The daily prayer time function 490, which is operated according to the steps depicted in block 492. When the daily prayer time function 490 is set to active, an icon or other graphical display, will show the next upcoming prayer time on the display monitor 32. The prayer time may also be associated with the your appointment function 312, such that the EDP 12 will ring for 20 seconds and the screen of the display monitor 32 will flash to alert the user when a prayer time has arrived. Time interface 494 may be accessed according to block 496. International times and local times may be displayed. The time and local time zone for the EDP 12 is preferably set through the time interface 494. The calendar interface 498 provides access to a calendar. Preferably the calendar is a simple 20 year calendar, in which every year may be accessed as depicted in block 500. The other function interface 502 is preferably as shown in the block 504, for expansion software or for later upgrades to the EDP system. The other function interface 502 provides a local for yet undefined f unctions.

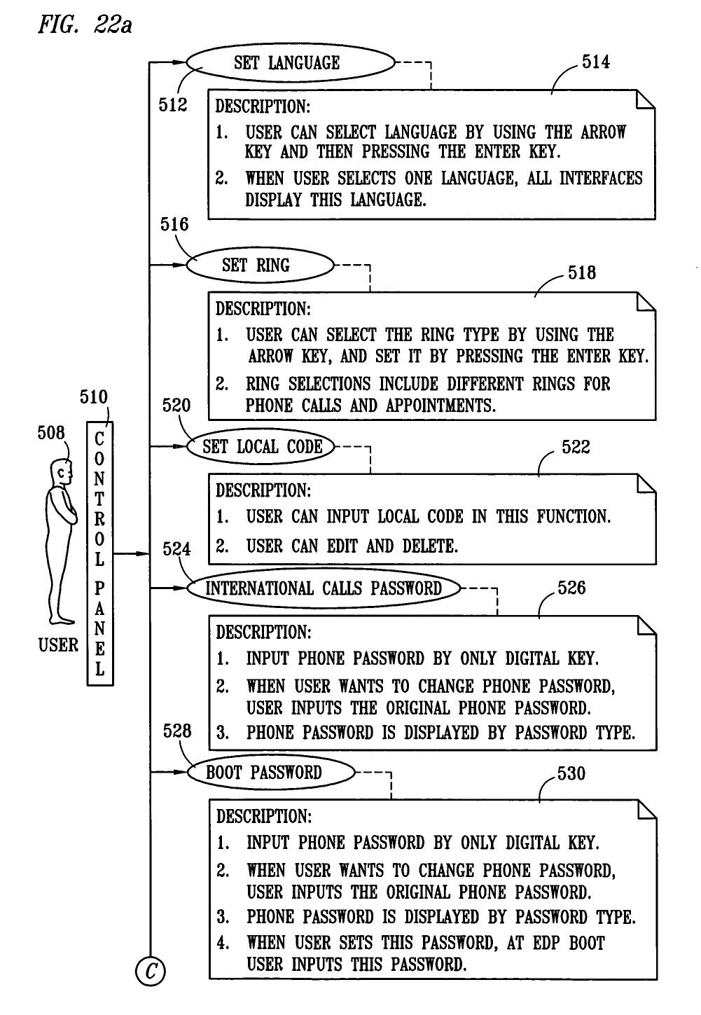

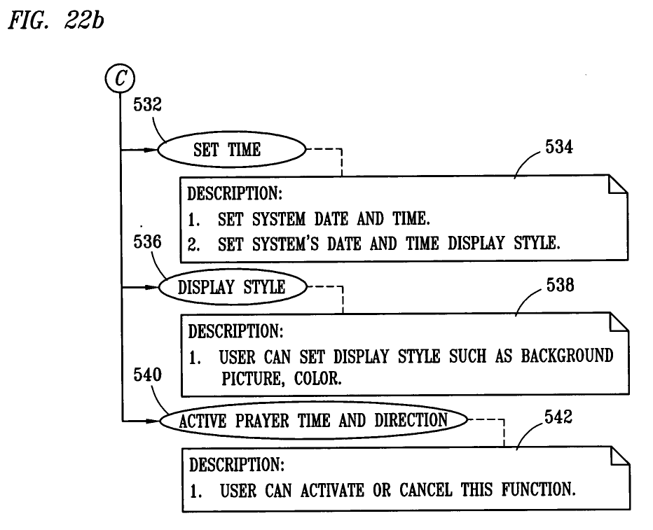

FIGS. 22a and 22b together provide a block diagram depicting a user 508 accessing a control panel interface 510 to review and select various settings for an EDP 12. In the interface 512 the user may set the language according to the block 514. The user can display various languages and select the language by using the keyboard direction keys, and page up and page down keys, and then pressing the enter key to select a particular language. Once the user selects the language, all interfaces are immediately set to the select language. The languages preferably include English and Arabic. The set ring interface 516 may be accessed according to block 518 to select the ring type or listen to ring types by using the keyboard direction keys, or the page up and page down keys, and then pressing the enter key to select a particular ring type. The user may also make different ring selections for different phone calls, different phone numbers, for different appointments, and for the daily prayer time notice. The interface 520 may be used to set local area codes according to block 522. The user can edit and delete local area codes for the local and regional calling areas. The international calls password for the EDP 12 may be set in interface 524, according to the block 526. Preferably, only the digital, or numeric, keypad 30 of the keyboard 20 is used to input phone passwords. The international calls password is a different password than the EDP activation code. The international calls password feature is provided for users to prevent unauthorized use of an EDP 12. When the user wants to change the international class password for an EDP 12, the user inputs the original phone password and then the EDP 12 displays the phone password by password type. The user may then enter a new international calls password for the EDP 12. The boot password may be accessed in the interface 528 according to block 530. Preferably, only the digital, or numeric, keypad 30 of the keyboard 20 is used to input phone passwords. On startup, the EDP 12 will preferably require the user to enter a new boot phone password. The user will input the original boot password for the EDP 12 on the numeric keypad 30, and then the EDP 12 will display the password type, that is, the description “Boot Password.” When the password type is displayed, the user will then enter the new boot password for the EDP 12. The user may also set the time according to time interface 532 in the control panel interface 510. The time is set according to block 534, in which the date and time, and the display style for the date and time are set for the EDP 12 according to block 534. The clock display style may be selected, such as analog or digital clock display. In the EDP display style interface 536, the user may select between various display styles for the EDP display monitor 32, as set forth in block 538. Various colors and backgrounds may be selected, and modes for showing various information display regions may be selected in the EDP display style interface 536, such as and or overlaid display regions and positioning of various display regions on the screen of the display monitor 32. The active prayer time and direction interface 540, provided for the user to activate or cancel daily prayer time display function according to block 542.

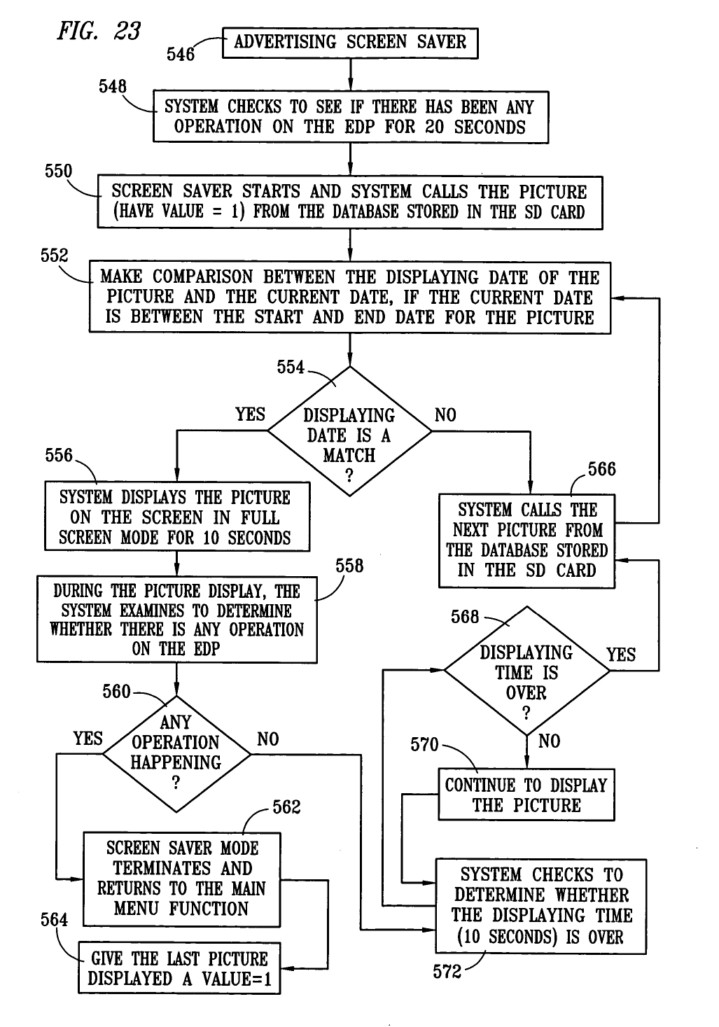

FIG. 23 is a flow chart describing operation of the EDP 12 for use of an advertising screen saver function to display advertisements when the EDP 12 is not in use. The advertising screen saver are preferably paid advertisements which will automatically display a graphical display advertising a service or a product, herein called a “picture.” The advertising screen saver starts in the step 546, and then moves to step 548 in which the EDP 12 monitors operation of the EDP 12 to determine whether there has been any operation on the EDP 12 for twenty seconds. If the EDP 12 determines that there has not been operation of the EDP 12 for twenty seconds, then in step 550 the screen saver feature starts and the system calls the next picture in a series stored in the SD card database having a high value of “1.” In step 552 the EDP 12 makes a comparison between the displaying dates of the picture and the current date according to the date and time settings of the EDP 12. The displaying dates of the picture are a start date and an end date, or one date one which the date is displayed, and which are stored in calendar fields associated with each of the pictures. If the current date is between the start and end date for the picture, then in step 554 the EDP 12 will determine if the display date is a match with the current date. In step 556 the EDP 12 will then display the picture on the display screen in full screen mode for 10 seconds. During the display of the picture, the EDP 12 examines to see if there is any operation of the EDP 12 in the step 558. If it is determined in step 560 that no operation is occurred on the EDP 12 during the picture display, the EDP 12 will then move to the step 572 to initiate steps 568, which determines whether the display time is over for the picture being displayed. If in step 560 it is determined that there is operation of the EDP 12, in step 562 the screen saver mode is terminated and the EDP 12 returns to the main menu function. Then the last picture displayed is given a value of “1,” which is the high value given to pictures which have not been displayed for a full ten seconds of allotted display time prior to user operation occurring on the EDP 12. This feature of assigning a high value in a field in the SD card database for a picture which is being displayed when another operation on the EDP 12 occurs, interrupting display of the picture, provides reasonable assurances that an advertiser's picture will be displayed without interruption for a complete ten second allotment of time. It should also be noted, that other lengths of displays times may be allotted for various pictures. If in the step 568 it is determined that the displaying time is not over, the EDP 12 will move to the block 570 and continue to display the picture being displayed. If it is determined in step 568 that the display time is over for the picture being displayed, the EDP 12 will move to step 566 and the next picture in the series of pictures stored in the SD cared database will be called up and the picture which has just been displayed for a complete allotment of time will be given a low value of zero. If in the step 554 it is determined that the displaying date of the current picture selected is not a match with the current date, then the EDP 12 in step 566 will move back to the step 566 to call up the next picture stored in the SD card database and determine whether the start in time for the picture matches the current start date.

Preferably, only one language may be selected at a time for use with the EDP 12. All phone book data may be stored on the SD card database, but in some embodiments, memory storage may be provided on the EDP 12. It should be noted that the pointing device 22 and selection buttons 24 and 26 may be used in place of the keyboard direction keys, and the page up and page down keys. The EDP 12 may also include SD cards 44 with databases which include a dictionary, a thesaurus, an encyclopedia, a language translator, and games, as well as advertisements and telephone directory listings.

The EDP provide provides the advantages of a telephone, in which your directory is your telephone. A complete phone book from a geographic area is provided in electronic form on the removable memory cards, preferably SD cards, which are removably mounted to the EDP. A user may store other relevant information on the removable memory card, including personal phone numbers, appointment information, notes, reminders, logs of calls, and such. The EDP requires activation on a periodic basis, preferably every year, such that the user is required enter a new activation code at the beginning of each period of time. Advertising may also be included in the database stored on the SD card, and may be scheduled to appear on the display monitor at specified dates and times during the year. The EDP determines whether an advertisement has been displayed for a specified time period, preferably ten minutes, without interruption by operation of the phone, and if not, the time for display of the advertisements will begin again. Graphical display information, such as advertisements, of one caller are displayed on the other caller's display if available and linked to the telephone number stored in the EDP database.

Although the preferred embodiment has been described in detail, it should be understood that various changes, substitutions and alterations can be made therein without departing from the spirit and scope of the invention as defined by the appended claims.

What is claimed is:

1. A electronic directory telephone comprising:
a telephone;
a display monitor;
removable memory media; and
a database stored on said removable memory media, said database including telephone listings and advertisements, wherein said advertisements include graphical displays and corresponding data fields which correspond to calendar dates on which said graphical displays are to appear on said display monitor.

2. The electronic directory telephone according to claim 1, further comprising memory in which a series of activation codes is stored, each activation code of said series corresponding to a respective term of operation for said electronic directory telephone, wherein a user is required to enter a respective one of said activation codes at the beginning of each of the terms.

3. The electronic directory telephone according to claim 2, wherein each of the terms of operation of said electronic directory telephone are approximately one year in duration.

4. The electronic directory telephone according to claim 2, wherein said database on said removable memory media includes an activation data field, which registers said removable memory media for use with said electronic directory telephone.

5. The electronic directory telephone according to claim 2, wherein said activation code for said electronic directory telephone is written to said activation date field of said database on said removable memory media.

6. The electronic directory telephone according to claim 5, wherein said removable memory media is at least one SD card.

7. The electronic directory telephone according to claim 6, further comprising data storage means for providing times for prayer and compass directions toward Qa'aba-Qebla, in Mecca.

8. The electronic directory telephone according to claim 1, further comprising:
memory in a series of activation codes is stored, each activation code of said series corresponding to a respective term of operation for said electronic directory telephone, wherein a user is required to enter a respective one of said activation codes at the beginning of each of the terms, wherein each of the terms of operation of said electronic directory telephone are approximately one year in duration;
wherein said database on said removable memory media includes an activation data field, which registers said removable memory media for use with said electronic directory telephone;
wherein said activation code for said electronic directory telephone is written to said activation date field of said database on said removable memory media; and
wherein said removable memory media is at least one SD card.

9. The electronic directory telephone according to claim 1, wherein said electronic directory telephone is operable for displaying graphical advertisements of a connected caller on said display monitor in response to associating a telephone number of the connected caller with the graphical advertisements which are stored in said database.

10. An electronic directory telephone, comprising:
a telephone;
a display monitor;
removable memory media;
data storage media; and
data stored in memory of said data storage media which includes a series of activation codes, each activation code of said series corresponding to a respective term of operation of said electronic directory telephone, wherein a user is required to enter a respective one of said activation codes at a beginning of each of the terms to activate said electronic data telephone for such respective terms.

11. The electronic directory telephone according to claim 10, wherein each of the terms of operation of said electronic directory telephone are approximately one year in duration.

12. The electronic directory telephone according to claim 10, wherein said data storage media at least in part includes a removable memory media, and a database is stored on said removable memory media which includes an activation data field to which data is written to register said removable memory media for use with said electronic directory telephone.

13. The electronic directory telephone according to claim 12, wherein said activation code for a current term of operation of said electronic directory telephone is said data which is written to said activation data field of said database on said removable memory media to register said removable memory media for use with said electronic directory telephone.

14. The electronic directory telephone according to claim 12, wherein said removable memory media is at least one SD card.

15. The electronic directory telephone according to claim 10, wherein data for times for prayer and compass directions toward Qa'aba-Qebla, in Mecca are stored in said data storage media of said electronic directory telephone for display to a user.

16. A method for displaying advertisements on a display monitor of an electronic directory telephone, comprising the steps of:
providing a removable memory media;
storing a database on said removable memory media, the database including telephone listings and advertisements, wherein the advertisements include graphical displays;
assigning corresponding data fields to respective ones of the advertisements;
storing calendar dates in the corresponding data fields;
comparing the stored calendar dates in the corresponding data field to a current calendar date to determine whether the stored calendar date matches the current calendar date; and
displaying the respective advertisements of the corresponding data fields in which the stored calendar dates match the current calender dates.

17. The method according to claim 16, further comprising the steps of:
monitoring the electronic directory telephone for user activity to determine periods of time when the electronic directory telephone is inactive; and
displaying the respective advertisements during the periods of time when the electronic directory telephone is inactive.

18. The method according to claim 17, further comprising the steps of:
detecting user activity prior to expiration of a selected time duration of display for a particular one of the respective advertisements;
storing a data bit in a data field corresponding to particular one of the respective advertisements;
discontinuing display of the particular one of the respective advertisements during the user activity; and then
after cessation of the user activity, returning to displaying the particular one of the respective advertisements for the complete selected time duration of display prior to displaying the next one of the respective advertisements.

19. The method according to claim 18, wherein the step of providing the removable memory media comprises replacing the removable memory media on a periodic basis with a replacement removable memory media having current telephone listings and current advertisements.

20. The method according to claim 19, further comprises:
providing data storage for said electronic directory telephone;
designating a plurality of data storage fields in the data storage, the plurality of data storage fields designated for storing respective codes of a series of activation codes;
assigning a series of activation codes to the electronic directory telephone;
storing the series of activation codes in the designated date storage fields of the data storage;
designating a duration for each term of operation for the electronic directory telephone; and
preventing use of the electronic directory telephone at the beginning of each term of operation until a user enters a particular code which matches the corresponding activation code for a particular one of the terms of operation of the electronic directory telephone.

21. The method according to claim 16, further comprising the steps of:
comparing a telephone number of a connected caller to telephone numbers stored in the database; and
displaying graphical advertisements of the connected caller on the display monitor of the electronic directory telephone in response to associating the telephone number of the connected caller with the graphical advertisements which are stored in said database.

22. A method for activating an electronic directory telephone, comprising the steps of:
providing data storage for said electronic directory telephone;
designating a plurality of data storage fields in the data storage, the plurality of data storage fields designated for storing respective codes of a series of activation codes;
assigning a series of activation codes to the electronic directory telephone;
storing the series of activation codes in the designated date storage fields of the data storage;
designating a duration for each term of operation for the electronic directory telephone; and
preventing use of the electronic directory telephone at the beginning of each term of operation until a user enters a particular code which matches the corresponding activation code for a current one of the terms of operation of the electronic directory telephone.

23. The method according to claim 22, wherein the step of assigning a series of activation codes comprises assigning a unique series of activation codes to each electronic directory telephone, such that each electronic directory telephone has a different series of activation codes from other electronic directory telephones.

24. The method according to claim 22, further comprising the steps of:
at the end of an ending term of the terms of operation, which marks the start of a beginning term of the terms of operation, deleting the activation code of the series of activation codes which corresponds to the ending term; and
designating the next one of the activation codes of the series of activation codes as the activation code for the beginning term of operation.

25. The method according to claim 22, further comprising the steps of:
at the end of an ending term of the terms of operation, which marks the start of a beginning term of the terms of operation, deleting the activation code of the series of activation codes which corresponds to the ending term;
designating the next one of the activation codes of the series of activation codes as the activation code for the beginning term of operation; and
wherein the step of assigning a series of activation codes comprises assigning a unique series of activation codes to each electronic directory telephone, such that each electronic directory telephone has a different series of activation codes from other electronic directory telephones.

26. The method according to claim 25, further comprising the steps of:
providing a removable memory media;
storing a database on said removable memory media, the database including telephone listings and advertisements, wherein the advertisements include graphical displays;
assigning corresponding data fields to respective ones of the advertisements;
storing calendar dates in the corresponding data fields;
comparing the stored calendar dates in the corresponding data field to the current date to determine whether the stored calendar date matches to current calendar date;
displaying the respective advertisements of the corresponding data fields in which the stored calendar dates match the current calender dates;
monitoring the electronic directory telephone for user activity to determine periods of time when the electronic directory telephone is inactive; and
displaying the respective advertisements during the periods of time when the electronic directory telephone is inactive.
